(19) United States
(12) Patent Application Publication
(10) Pub. No.: US 2006/0086658 A1
(43) Pub. Date: Apr. 27, 2006

(54) Apparatus and method for processing fluids from oil wells

(76) Inventors: Wayne Hesse, Glace Bay (CA); Hannu Juhani Salokangas, Edmonton (CA)

Correspondence Address: THOMAS E. MALYSZKO, SUITE 700, 205 - 5 AVENUE, S.W., CALGARY, AB, T2P 2V7, CA

(21) Appl. No.: 10/970,010

(22) Filed: Oct. 22, 2004

(51) Int. Cl. B01D 21/26

(52) U.S. Cl. 210/512.2

(57) ABSTRACT

An apparatus and method for processing oil well fluids has two pressure vessels. A first vessel has hydrocyclones for separating the fluids into water and oil phases. The oil phase is retained in an overflow chamber to provide residence time for further separation of residual water phase, which is recycled again through the hydrocyclones. A second inclined vessel has a processing chamber for receiving the water phase from the first vessel, and provides residence time to urge separation of residual oil phase. Coalescing media in the processing chamber enhance this separation. The residual oil phase is fed into a heated treating chamber along with the oil phase from the first vessel to provide a second residence time for further separation of residual water phase. Clarified processed water and oil exit in dedicated steams from the second vessel.

### FIELD OF THE INVENTION

The present invention relates to an apparatus and method for processing oil well fluids, and in particular relates to an arrangement using hydrocyclones, residence times, coalescing media and heat to provide clarified streams of produced water and oil.

### BACKGROUND OF THE INVENTION

Crude oil produced from oil wells typically contains various fluids, principly oil, gas and water, and particulate matter. Components of the crude oil must be separated to produce a pay stream, namely an “oil phase”, that is acceptable for transportation though pipeline networks and to refineries for further processing. Some oil wells produce large volumes of water which must be separated efficiently to realize an economically viable pay steam.

Until now, the water separated from the pay stream, termed “produced water”, was simply disposed of or re-injected after water treatment processing sometimes many miles from the originating wells. In water drive tertiary production, produced water is used to boost or maintain reservoir or well pressures and production. Unfortunately, even after primary treatment, the produced water contains varying levels of impurities, such as small amounts of residual oil. Those levels of impurities, and the prior art separation devices and processes which processed the produced water, were deemed acceptable based on the laws and regulations at the time. However, the environmental regulations are becoming more stringent in many jurisdictions, particularly as concerns grow over available ground water supply and quality in rural and small communities that rely on sometimes the same freshwater supplies. These changes also effect off-shore locations and installations primarily because of environmental disposal regulations.

Well sites can produce large volumes of produced water. Storage of the produced water in containers and ponds, or transport of the produced water for treatment at locations remote from the well site, is not a desireable nor a viable is long term solution economically and environmentally. What is therefore desired is a novel apparatus and process for processing fluids from an oil well that is capable of being located at the well site or close to the well site, and that overcomes further limitations and disadvantages of the existing processes. The new apparatus and process should separate the fluids into an oil phase, or pay stream, acceptable for transportation though pipeline networks and to refineries for further processing, and into a water phase suitable for disposal or re-use on site. The process should be efficient for cost effective separation of the fluids into the desired phases, and the apparatus should have few if any moving mechanical parts for cost effective manufacturing, maintenance and operation. The apparatus should also be relatively compact for advantageous use on offshore platforms where space and floor area are at a premium. The apparatus and process should preferably employ a hydrocyclone tube arrangement of the type shown in U.S. Pat. No. 5,965,021 to provide a simplified fluid path and maximize the separation efficiency over a wide range of differential pressures, and thus provide high turndown capacities as compared to conventional designs. Coalescing media should also be employed for enhanced separation of the oil phase from the water phase for further purification.

### SUMMARY OF THE PRESENT INVENTION

According to the present invention, there is provided in one aspect an apparatus for processing fluids from an oil well comprising:

a first elongate pressure vessel having an inlet chamber at one end for receiving said fluids, an overflow chamber at an opposed end, and an underflow chamber therebetween;

a hydrocyclone tube arrangement, having at least one hydrocyclone tube, located within said underflow chamber for receiving said fluids from said inlet chamber and for urging separation of said fluids into a first phase and a second phase, wherein said first phase is discharged into said underflow chamber and said second phase is discharged into said overflow chamber; and,

said overflow chamber adapted to provide said second phase with sufficient residence time for further separation of residual first phase therefrom, and a first outlet for discharging said second phase therefrom.

The apparatus further including:

an second elongate vessel having a processing chamber for receiving said first phase from said underflow chamber and an adjoining treating chamber for receiving said second phase from said overflow chamber;

said processing chamber adapted to provide said first phase with sufficient residence time to urge separation of residual second phase therefrom, and having means for transporting said residual second phase to said treating chamber; and,

said treating chamber adapted to provide said second phase and residual second phase with residence time to urge further separation of residual first phase therefrom, and having means for heating said second phase to enhance said further separation.

In another aspect the invention provides a method of processing fluids from an oil well comprising:

providing a separation apparatus for receiving said fluids, said apparatus being in the form of a pressure vessel having a hydrocyclone tube arrangement located therewithin;

passing said fluids through said hydrocyclone tube arrangement to urge separation of said fluids into a heavier phase and a lighter phase; discharging said heavier phase from said pressure vessel; and,

providing said lighter phase with residence time sufficient for urging separation of residual heavier phase therefrom.

The method further includes:

providing a treating apparatus for receiving said fluid streams, said apparatus being in the form of a vessel having a processing chamber for receiving said heavier phase stream and a treating chamber for receiving said lighter phase stream;

providing said heavier phase with sufficient residence time to urge separation of residual lighter phase therefrom;

transporting said residual lighter phase to said treating chamber; providing said lighter phase and said residual lighter phase with residence time to urge further separation of residual heavier phase therefrom; and,

heating said treating chamber to enhance said further separation.

### BRIEF DESCRIPTION OF THE DRAWING FIGURES

Embodiments of the invention will now be described, by way of example only, with reference to the accompanying drawings, wherein:

FIG. 1 shows a preferred embodiment of a separation unit of an apparatus according to the present invention for processing fluids from an oil well into lighter and heavier phases;

FIG. 2 shows a degassing unit for the fluids, namely a raw crude emulsion, prior to their introduction into the separation unit of FIG. 1;

FIG. 3 shows a preferred embodiment of a treatment unit of an apparatus according to the present invention for processing the lighter and heavier phases of the fluids simultaneously;

FIG. 4 shows an alternate embodiment of the treatment unit of FIG. 3;

FIG. 5 shows the separation unit of FIG. 1 employed in series with the treatment unit of FIG. 3 to perform a preferred embodiment of the method of processing of the present invention; and,

FIGS. 6a and 6b show in greater detail the elevation and end views, respectively, of a removable hydrocyclone tube arrangement for location within the separation unit of FIG. 1.

### DESCRIPTION OF PREFERRED EMBODIMENTS

The figures show an apparatus and method for processing fluids, such as those extracted or produced from an oil well, according to the present invention. The primary components of the apparatus are a separation unit, or vessel, 20 for receiving the fluids, which preferably have been degassed, and a downstream treatment unit, or vessel 60. The separation unit separates the fluids into a heavier water phase and a lighter oil phase, which are then fed into the treatment unit for further processing into streams of produced water and crude oil for further use downstream. Residual gasses are also extracted from the treatment unit. It is intended to commercially identify the separation and treatment units individually by the trademarks MAXIS and CLARIS, respectively, and the apparatus and process as a whole by the trademark CLARAMAX.

It is noted that terms such as “front”, “rear”, “top” or “upper”, “bottom” or “lower” and the like may be used herein for identifying certain features of the apparatus relative to ground or other reference point. The use of these terms is not intended to limit the use or orientation of the apparatus. Further, when describing the invention, all terms not defined herein have their common art-recognized meaning.

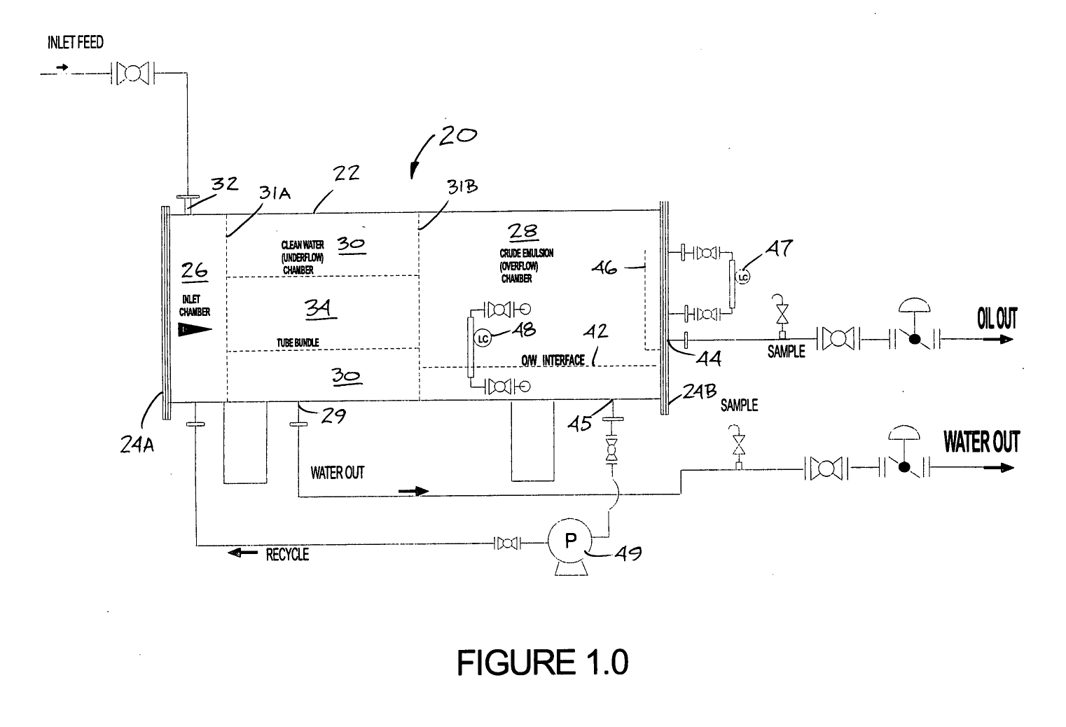

The apparatus and process will now be described in greater detail with reference first to FIG. 1. The separation unit 20 is defined by an elongate hollow vessel 22 capable of withstanding internal pressures. Although it may take various shapes, the vessel's shell is preferably cylindrical and has a first plate 24a capping a first, or front, end of the vessel and a second plate 24b capping a second, or back, end of the vessel. These “end caps” 24a, 24b may also be spherical as is common in pressure vessels, but is not preferred herein. The end caps 24a, 24b are preferably bolted onto the shell for easy removal and access thereinto for maintenance or repair.

The vessel 22 has three primary chambers capable of holding fluids under pressure: an inlet chamber 26 at the front end for receiving the degassed fluids through an inlet connection 32, an overflow chamber 28 at the opposed back end, and an underflow chamber therebetween, with suitable partitions 31a, 31b separating the chambers. The underflow chamber 30 is adapted to hold a hydrocyclone tube arrangement 34 for receiving the fluids from the inlet chamber 26 and for urging separation of the fluids into a first, heavier, water phase which is discharged into the underflow chamber 30, and into a second, lighter, oil phase which is discharged into the overflow chamber 28. The water phase is retained in the underflow chamber for a short time and discharged through an underflow outlet 29 for further processing.

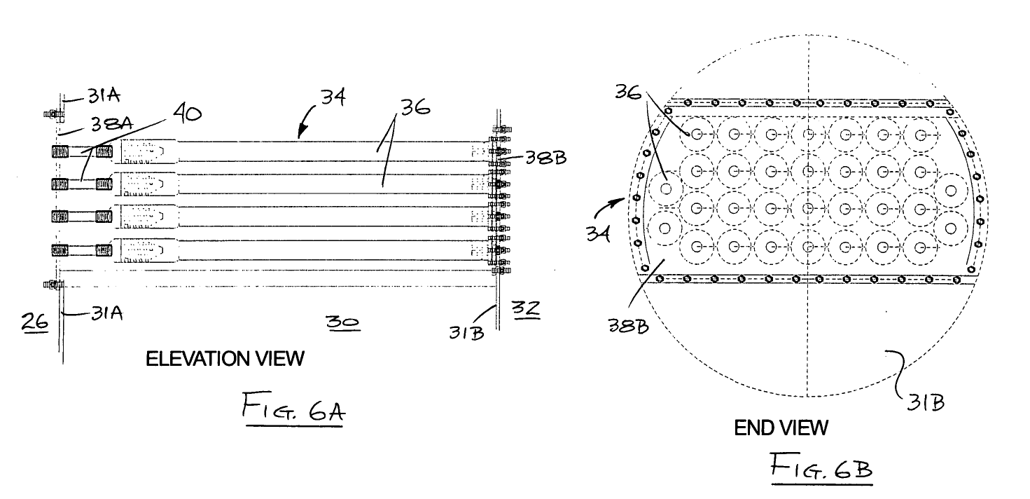

The hydrocyclone tube arrangement 34 should have at least one hydrocyclone tube or similar device for performing the desired function. A preferred hydrocyclone tube for this operation is of the type described in applicant's U.S. Pat. No. 5,965,021, and which is incorporated herein by reference. This type of hydrocyclone has a single inlet for fluids, and two outlets—one for a lighter oil phase (aka “reject outlet”) and at least one for a heavier water phase (aka “accept outlets”). As the volume of fluid to be processed from oil wells is typically much greater than the capacity of a single hydrocyclone tube, a preferred parallel tube arrangement 34 is shown in FIGS. 6a and 6b where numerous hydrocyclone tubes 36 are arranged in a parallel relationship to permit the incoming fluids to be equally distributed throughout the arrangement. The inlet and outlet ends of the tubes are fixed on end plates 38a, 38b, respectively, to form the arrangement, which may then be installed as a unitary assembly inside the vessel 22 and can incorporate end plates to form the fluid tight chamber partitions 31a, 31b. The plates 38a, 38b are preferably bolted internally to internal partition support rings to allow removal of the tube arrangement from the vessel for repair or replacement of one or more of the tubes. As the size of the underflow chamber 30 may vary to accommodate given fluid flows, hollow feed tubes 40 for delivering fluids to the hydrocyclone inlets may be provided where the length of the underflow chamber 30 is required to exceed the length of the tubes 36.

The overflow chamber 28 receives the discharged second, lighter, oil phase from the hydrocyclone tube arrangement, and is sized to provide this oil phase with a residence time sufficient to urge further separation by gravity of residual first, heavier, water phase therefrom. Simply put, after initial separation occurs in the hydrocyclone tubes, undesirable water is given some residence time to sink from the desirable oil which floats, thus creating an oil/water (“o/w”) interface 42 in the chamber. This portion of the process does not always remove all impurities (i.e. water droplets in the oil phase, and oil droplets in the residual water phase), nevertheless the oil phase is discharged from an elevated first overflow outlet 44 and the residual water phase is discharged from a bottom second overflow outlet 45 for further processing. The oil phase may reach the first outlet 44 only over the top of a surrounding baffle 46, which limits discharge of any residual water phase through the first outlet. A first level control arrangement 47 controls a valve at the outlet 45 for timely discharge of the oil phase.

The residual first water phase being discharged from the second outlet 45 may be transported to a remote location for storage, disposal or the like. However, in the preferred embodiment of the separation unit the discharged residual water phase from the overflow chamber 28 is “recycled” by returning it to the inlet chamber 26 where it mixes with the fluids therein and is processed again through the hydrocyclone tube arrangement 34. A second level control arrangement 48 communicates with a pump 49 for pumping the residual water phase to the inlet chamber. This control arrangement 48 also controls the level of the oil/water interface 42 to ensure it remains within a desired range and to maximize the residence time of the second oil phase within the overflow chamber 28.

The desire in this invention is to have the three chambers 26, 28 and 30 within one vessel 22 as advantages are realized for many applications, such as improved fluid separation in a compact design. It will be appreciated that the overflow chamber may be made larger or smaller as needed to accommodate a specified discharge from the hydrocyclone tubes. Further, the overflow chamber may be provided remotely from the vessel, such as a larger chamber for more residence time for example, but this is not preferred in many applications as the configuration is not compact.

During normal operation the separation unit may operate unattended and relatively maintenance free. The operation of the hydrocyclones, namely the cyclonic vortex in the single separation stage within, can be controlled by increasing or decreasing the back pressure on the hydrocyclone tube arrangement, resulting in a higher or lower flow rate through each hydrocyclone outlet. The noted back pressure is the pressure difference between the inlet chamber and overflow chamber (first pressure drop) and the pressure difference between the inlet chamber and the underflow chamber (second pressure drop). A Pressure Drop Ratio (PDR) is obtained by dividing the first pressure drop by the second pressure drop. Good results for vortex operation have been achieved as the PDR ratio approaches 1.0. As the hydrocyclones employed herein function on a linear flow principle which allows operation at low pressures, a typical separation vessel application should not require differential pressure drops in excess of 10 psig. Based on this separation unit's design, means for controlling the backpressure should come primarily from varying the pressure in the overflow chamber 28.

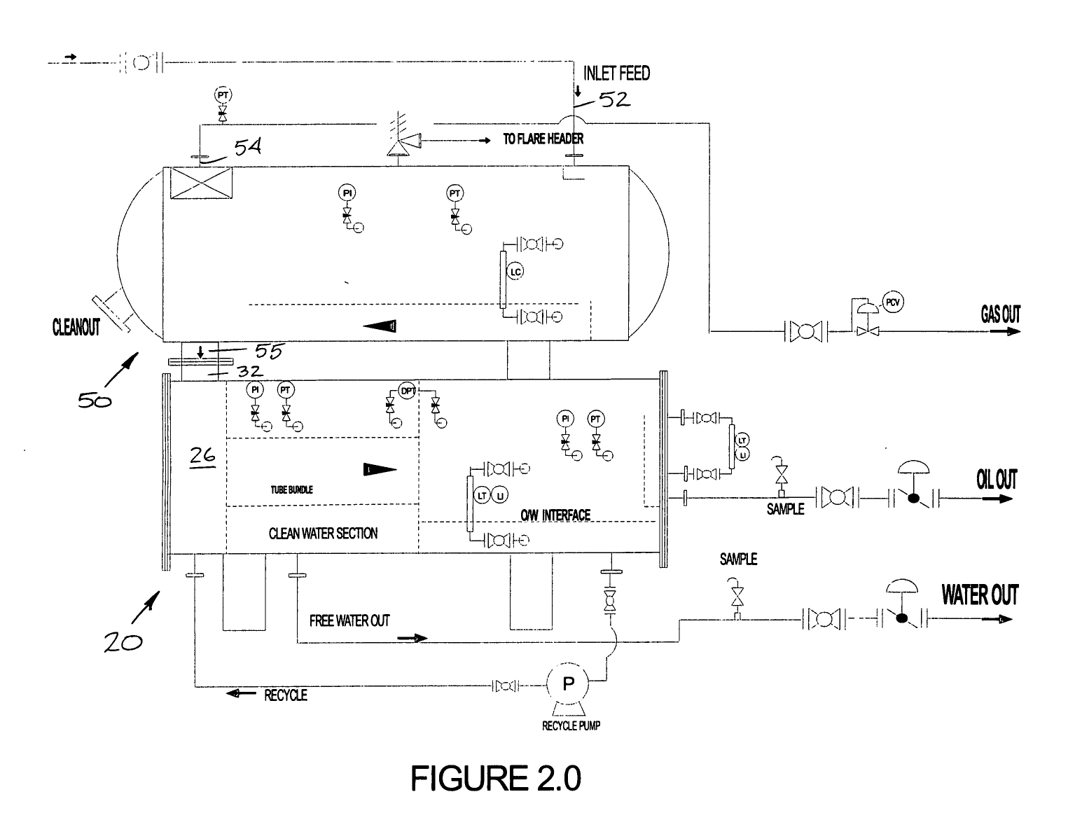

In an alternate embodiment of the present invention a degassing unit 50 may be provided immediately upstream of the separation unit 20, as by mounting the degassing unit horizontally thereon as shown in FIG. 2, for pre-treating fluids from an oil well. An inlet 52 feeds the fluids into the vessel where gas is urged from the fluids in a known manner. The removed gas is expelled through a top mounted first outlet 54 and the largely “degassed” fluid is discharged through a bottom mounted second liquid outlet 55 and into the inlet chamber 26 through its inlet connection 32. An advantage of employing this unit is that when it operates with a minimum liquid level, it allows the lower separation unit 20 to operate in a fully flooded condition, stabilizing the operation of the separation unit.

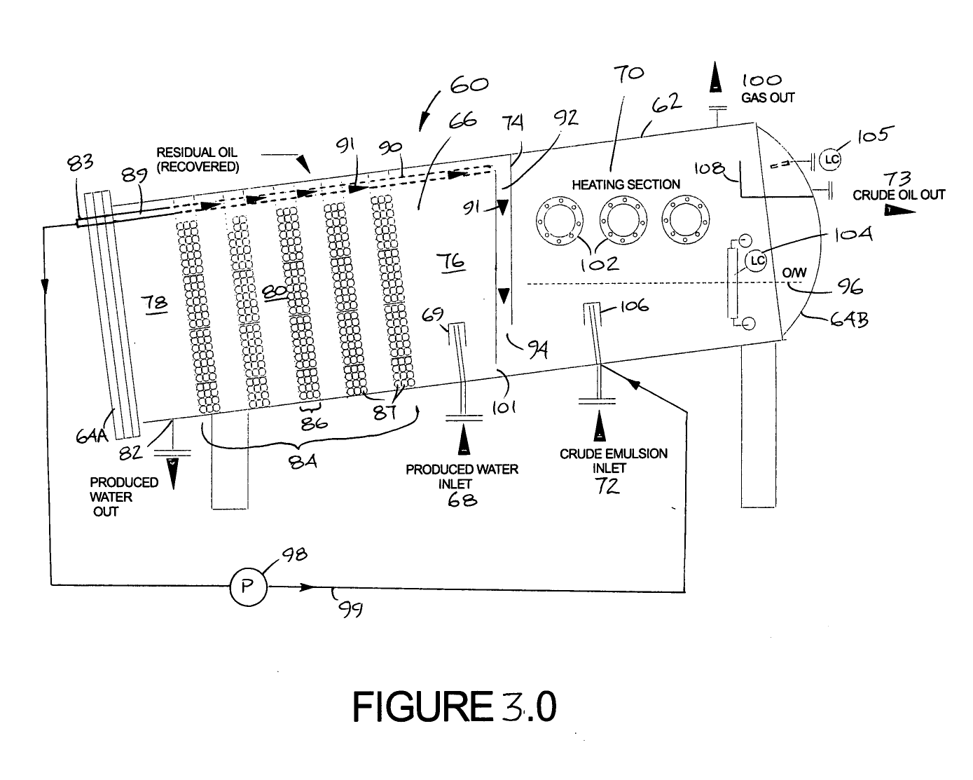

Referring now to FIG. 3, the treatment unit 60 receives the separated fluids from the separation unit, or alternately from a different source. The treatment unit is defined by an elongate hollow pressure vessel 62 which is preferably tilted, or inclined, at an oblique angle to the horizontal for reasons outlined later. Although it may take various shapes, the vessel's shell is preferably cylindrical and has a first plate 64a capping a first, lower end of the vessel and a second, spherical cap 64b closing a second, upper end of the vessel. These “end caps” 64a, 64b may be made in any suitable shape as desired by a designer, and are preferably bolted onto the shell for easy removal and access thereinto for convenient inspection, maintenance, repair or replacement of components, such as the coalescing media 87 discussed below.

The pressure vessel 62 is capable of performing concurrent fluid processing functions in two primary chambers, namely in a processing chamber 66 at the lower end for receiving a first, heavier water phase (containing residual oil) through a processing inlet 68 (preferably from beneath the vessel), and in an adjoining treating chamber 70 for receiving a second, lighter crude oil emulsion phase through an treating inlet 72. A suitable first partition 74 separates the chambers, although not in a fluid tight manner as will be seen later. The processing chamber 66 provides the incoming water phase with sufficient residence time to urge separation by gravity of residual lighter phase therefrom, and provides means for transporting the residual lighter phase to the treating chamber 70. The treating chamber simultaneously provides the incoming lighter phase and residual lighter phase (from the processing chamber) with residence time to urge by gravity further separation of residual heavier phase therefrom, and enhances such separation by heating the lighter phase.

Referring more specifically to the processing chamber 66, it has three sectors, namely: an inlet portion 76 at one end of the chamber for receiving the heavier phase through the inlet 68 (with a diverter 69 to reduce disturbance of fluids in the inlet portion); an outlet portion 78 at an opposed end having a first processing outlet 82 for discharging the heavier phase (by gravity or by pumping) after being processed in the chamber; and, an intermediate portion 80 between the inlet and outlet portions 76, 78 for housing a coalescing media arrangement 84. The coalescing media arrangement 84 consists of at least one radially stacked array, or bed, 86 made up of numerous coalescing media 87 extending radially across the full diameter of the chamber for urging further separation of residual lighter phase from the heavier phase being passed therethrough. Each array 86 preferably contains several types of random or fixed coalescing media 87. The media provide high surface area for the coalescence and flocculation of lighter/oil phase droplets to a size large enough to permit removal from the heavier/produced water phase. In the preferred embodiment of FIG. 3 the arrangement 84 has five arrays 86 placed in series and spaced from one another is to process a given volume, or through-put, of the heavier phase. The spaces proved the residual lighter phase with a further opportunity to migrate to the top of the chamber. Gravity is used as a means for urging travel of the heavier phase through the coalescing media arrangement 84 from the inlet to outlet portions 76, 78 by titling the vessel as noted earlier. Fluid hydraulics provide further means for urging this travel when the heavier phase is discharged from the first outlet 82.

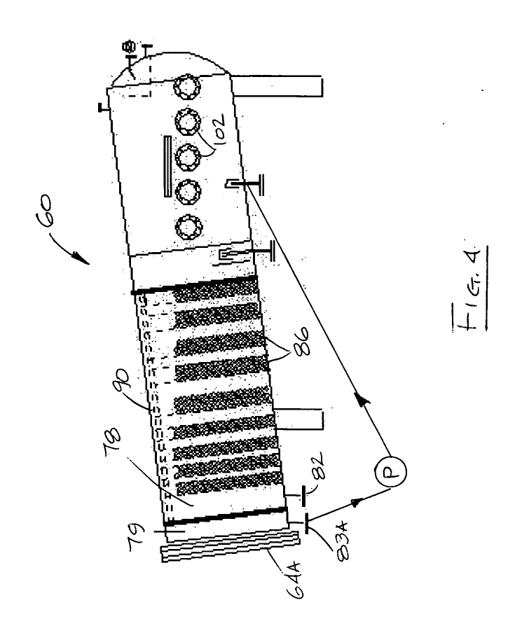

As the heavier phase moves through the arrangement 84 and the residual lighter phase separates and naturally migrates to the peak of the chamber, a means of transporting is provided at the peak for transporting the residual lighter phase to the treating chamber 70 for further processing. The transporting means is preferably in the form of an elongate perforated conduit 90 which extends along the chamber's peak and across the tops of the coalescing media arrays 87, and communicates with a vertically oriented channel 92 located adjacent the chamber partition 74 with a lower end opening 94 into the treating section 70. Once the residual lighter phase enters the conduit 90 through its perforations, this lighter phase should travel up the conduit (in the direction of arrows 91) and down the channel 92 exiting into the treating chamber below the o/w interface 96. An advantage here is that mechanical means are avoided for the transport of the residual lighter phase. However, certain applications may require pumping, in which case the conduit 90 may optionally be extended at its lower end via an extension 89 to a second processing outlet 83 in the end cap 64a, from where a pump 98 delivers the residual lighter phase through piping 99 into the treating chamber below the o/w interface, such as connecting through the treating inlet 72. In an alternate embodiment shown in FIG. 4, the perforated conduit 90 is extended to an auxiliary outlet portion 79 formed by a second radially extending partition 75 in the outlet portion 78. The residual lighter phase may therefore discharge from the extended conduit 90 into the auxiliary portion 79 and be pumped from the auxiliary processing outlet 83a to the treating chamber in the same manner as described immediately above. FIG. 4 also illustrates how the number of coalescing arrays 86 and heaters 102 may be varied to suit prescribed processing throughput.

The treating chamber 70 should have at least one heater located above the o/w interface 96 for direct heating of the lighter and residual lighter phases therein, and indirect heating of the heavier phase below, to enhance further separation of heavier (emulsified water droplets) and lighter phases, and to urge removal of any gas phase (which can discharge through an upper gas outlet 100). The thermal addition to the lighter phase (i.e. crude emulsion) enhances coalescence and recovery of the heavier phase (i.e. residual entrained water droplets) by reducing the viscosity of the continuous crude oil phase. In the preferred embodiment of the treating chamber 70 three electrical immersion heaters with external access ports are provided to process an anticipated fluid volume for that size of vessel, and to better distribute heat and more evenly reduce viscosity of the lighter phase. The treating chamber includes a means for accessing the processing chamber 66 in the form of a small opening 101 at the bottom end of the partition 74 to allow any heavier phase in the treating chamber to travel into the processing chamber. Hence, the opening 94 of the channel 92 is located above, or higher than, the small opening 101 to avoid re-entry of the residual lighter phase from the channel 92 to the processing chamber's inlet portion 76. A first level controller 104 communicates with valves at the lighter phase outlet 73 above the heaters to ensure the o/w interface 96 remains within a desired range, namely below the heaters and above the diverter 106 atop the inlet 72, as well as above the opening 94 of the channel 92. The level controller 104 also maximizes the residence time of the lighter phase fluids within the treating chamber 70 by controlling automated control valves that remove and/or recycle the water phase from the overflow chamber. A second level controller 105 controls a valve at the outlet 73 for timely discharge of the lighter oil phase. A baffle, or oil box, 108 of a similar structure and function as baffle 46 is provided at the location of the first phase outlet 73 and second switch 105.

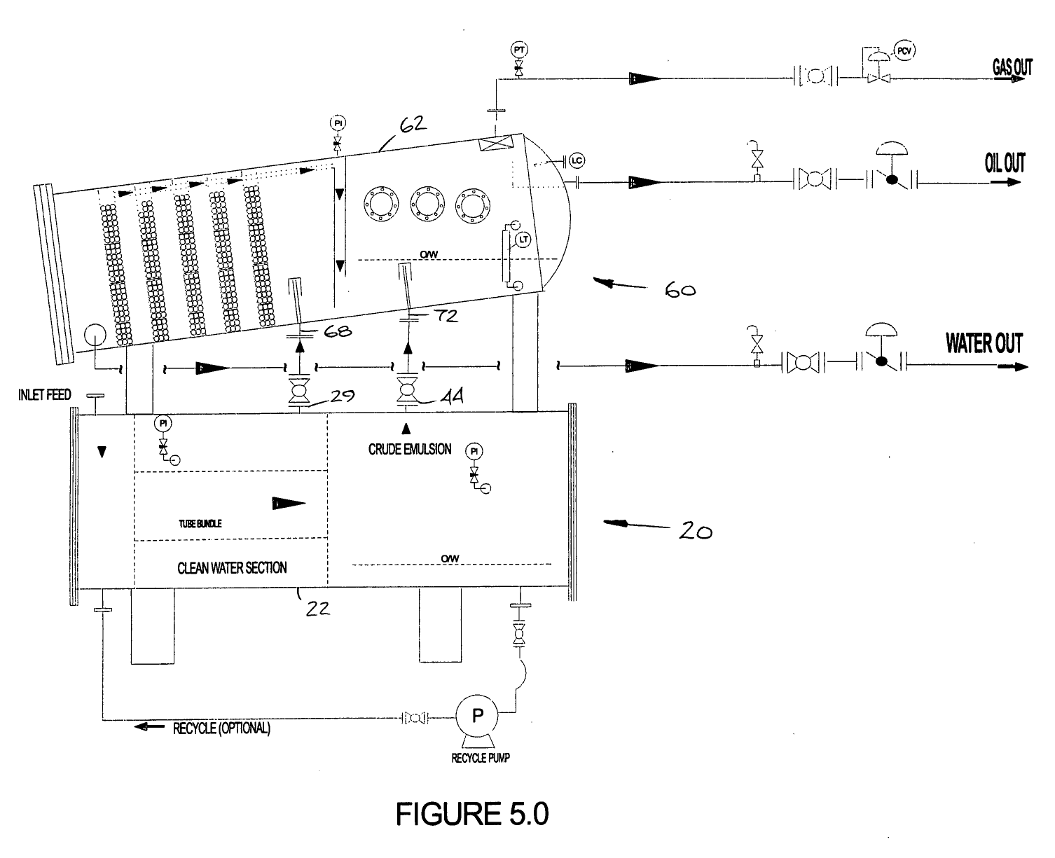

An advantage of the present apparatus is that the separation and treatment units may form a compact arrangement, such as by stacking the treatment unit atop the separation unit as shown in FIG. 5. The illustrated arrangement provides for a short and quick transfer of fluids therebetween, such as directly transferring the heavier phase from the underflow outlet 29 to the processing inlet 68, and from the first overflow outlet 44 to the treating inlet 72. Such arrangement is particularly suitable for offshore platforms where space and floor area are at a premium.

The process and some of the many advantages of the present invention, as provided by the above-described apparatus, should now be better understood. In essence, the process passes fluids from an oil well through at least one hydrocyclone to urge separation into a heavier phase and a lighter phase. The heavier phase is then provided with a residence time sufficient for gravity to urge separation of residual lighter phase therefrom. Concurrently, the lighter phase is provided with a first residence time sufficient for gravity to urge separation of residual heavier phase, and then the lighter phase is provided with a second residence time and thermal treatment for gravity to urge further separation of more residual heavier phase. The lighter phase is heated during the second residence time to enhance the separation.

The figures and reference numerals will now be used to set out further inventive aspects of the process in greater detail. The incoming fluids from the oil well, which should already be substantially degassed, or if not they may be degassed in the degassing unit 50, enter the inlet chamber 26 of the separation unit 20 under pressure. The fluids are then passed through the hydrocyclone tube arrangement 34 which urges separation into a heavier water phase and a lighter oil phase. The heavier phase is discharged into the underflow chamber 30 where it is stored for a short time until it is discharged from the separation unit for further processing or storage. The lighter phase is discharged into the overflow chamber 28 where it is provided with a residence time sufficient for urging separation by gravity of residual heavier phase therefrom, thus creating the o/w interface 42. The size of the chamber 28 (and the other chambers in this invention) may be varied during manufacture to provide the desired residence time, depending on anticipated operational parameter (e.g. expected volume of fluids from the oil well). Although the overflow chamber may be provided outside the separation unit, this is not preferred for earlier noted reasons. The residual heavier phase recovered from the overflow chamber 28, is returned or recycled to the hydrocyclone tube arrangement 34, via the inlet chamber 26, for further processing therethrough, whereas the lighter phase is discharged from the overflow chamber 28 for further processing. Means for monitoring the o/w interface 42 in the form of the second level control arrangement 48 maintains the interface at a desired level.

The heavier and lighter phases are further processed in the treatment unit to further separate, namely to “polish”, “purify” or “clarify”, the phases. The phases preferably arrive from the separation unit 20, as in the present invention, although optionally they may arrive from an alternate source. The heavier phase (discharged from the underflow chamber 30) is received in the processing chamber 66 and the lighter phase (discharged from the overflow chamber 28) is received in the treating chamber 70. The heavier phase is provided with sufficient residence time to urge separation by gravity of residual lighter phase therefrom. This heavier phase is also passed through the coalescing media arrangement 84 to further urge separation of residual lighter phase therefrom. The residual lighter phase is then transported to the treating chamber for further processing. The heavier phase is urged to pass through the coalescing media arrangement by tilting the longitudinal axis of the treatment unit at an oblique angle to the horizontal, and further by fluid hydraulics when the heavier phase resulting from this process is discharged at the far end of the coalescing media arrangement for disposal or re-use. The lighter phase and the introduced residual lighter phase in the treating chamber 70 are provided with residence time to urge further separation of residual heavier phase therefrom, thus forming the o/w interface 96. The treating chamber, and specifically the lighter phase, is heated with heaters 102 to enhance this further separation. The residual heavier phase is allowed to pass from the bottom of the treating chamber into the bottom of the processing chamber 66 for further processing. Means for monitoring the o/w interface 96 is in the form of first level control switch 104 to maintain the interface at a desired level. The lighter oil phase resulting from the present process is discharged from the treating section for further use.

The heavier water phase leaving the treatment unit at one end should preferably be “clean” enough for disposal or re-use according to applicable industry or environmental standards, and the lighter oil phase exiting the other end of the treatment unit should preferably be “dry” enough for transport through an oil pipeline according to applicable industry standards as a pay stream.

Further aspects of the invention include:

The hydrocyclones may optionally be replaced with blanking plates to achieve further turndown from the maximum and minimum design flow rates; and,

In an alternate embodiment of the treatment unit a single feed inlet is provided (rather than the dual inlets 68, 72) to deliver a crude emulsion mixture for processing therein into lighter and heavier phases.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below. For instance, the fluids and phases chosen for description above are those typically associated with an oil well, namely oil and produced water. However, it will be appreciated that the present apparatus and method may be applicable to other types of fluids in the petroleum industry, or those in other industries, such as the chemical or petrochemical industries that require the separation or classification of two fluids of different densities.

We claim:

1. An apparatus for processing fluids from an oil well comprising:
a first elongate pressure vessel having an inlet chamber at one end for receiving said fluids, an overflow chamber at an opposed end, and an underflow chamber therebetween;
a hydrocyclone tube arrangement, having at least one hydrocyclone tube, located within said underflow chamber for receiving said fluids from said inlet chamber and for urging separation of said fluids into a first phase and a second phase, wherein said first phase is discharged into said underflow chamber and said second phase is discharged into said overflow chamber; and,
said overflow chamber adapted to provide said second phase with sufficient residence time for further separation of residual first phase therefrom, and a first outlet for discharging said second phase therefrom.

2. The apparatus of claim 1 wherein said underflow chamber has a second outlet for discharging said residual first phase, and means for returning said residual first phase into said inlet chamber for further processing through said hydrocyclone tube arrangement.

3. The apparatus of claim 1 wherein said hydrocyclone tube arrangement comprises a plurality of hydrocyclones located in parallel.

4. The apparatus of claim 1 further including means for varying backpressure on said hydrocyclone tube arrangement to control separation efficiency.

5. The apparatus of claim 1 wherein a baffle is provided at said first outlet to avoid discharging said residual first phase therethrough.

6. The apparatus of claim 1 further including a degassing unit located upstream of said pressure vessel for pre-treating said fluids prior to entering said inlet chamber.

7. The apparatus of claim 1 further including:
an second elongate vessel having a processing chamber for receiving said first phase from said underflow chamber and an adjoining treating chamber for receiving said second phase from said overflow chamber;
said processing chamber adapted to provide said first phase with sufficient residence time to urge separation of residual second phase therefrom, and having means for transporting said residual second phase to said treating chamber; and,
said treating chamber adapted to provide said second phase and residual second phase with residence time to urge further separation of residual first phase therefrom, and having means for heating said second phase to enhance said further separation.

8. The apparatus of claim 7 wherein said processing chamber comprises an inlet portion having a processing inlet for receiving said first phase, an outlet portion having a processing outlet for discharging said first phase after being processed in said chamber, and an intermediate portion between said inlet and outlet portions for housing a coalescing media arrangement for urging further separation of said residual second phase from said heavier phase.

9. The apparatus of claim 8 wherein said processing chamber further includes means for urging travel of said first phase through said coalesing media arrangement from said inlet portion to said outlet portion comprising tilting said second vessel at an oblique angle to the horizontal.

10. The apparatus of claim 9 wherein said means for urging further includes discharging fluids out said processing outlet.

11. The apparatus of claim 7 wherein said means for transporting comprises a perforated conduit located at an upper end of said processing chamber and a channel in fluid communication therewith having a lower end open to said treating chamber for discharging said residual second phase thereinto.

12. The apparatus of claim 11 wherein said treating chamber includes a means for accessing said processing chamber to allow any first phase in said treating chamber to travel into said processing chamber.

13. An apparatus for processing fluids from an oil well having a lighter phase and a heavier phase comprising:
an elongate vessel having a processing chamber for receiving said heavier phase and an adjoining treating chamber for receiving said lighter phase;
said processing chamber adapted to provide said heavier phase with sufficient residence time to urge separation of residual lighter phase therefrom, and having means for transporting said residual lighter phase to said treating chamber; and,
said treating chamber adapted to provide said lighter phase and residual lighter phase with residence time to urge further separation of residual heavier phase therefrom, and having means for heating said lighter phase to enhance said further separation.

14. The apparatus of claim 13 wherein said processing chamber comprises an inlet portion having a processing inlet for receiving said heavier phase, an outlet portion having a processing outlet for discharging said heavier phase after being processed in said chamber, and an intermediate portion between said inlet and outlet portions for housing a coalescing media arrangement for urging further separation of said residual lighter phase from said heavier phase.

15. The apparatus of claim 14 wherein said processing chamber further includes means for urging travel of said heavier phase through said coalesing media arrangement from said inlet portion to said outlet portion comprising tilting said vessel at an oblique angle to the horizontal.

16. The apparatus of claim 15 wherein said means for urging further includes discharging fluids out said processing outlet.

17. The apparatus of claim 16 wherein said processing inlet and processing outlet are located at a base of said processing chamber.

18. The apparatus of claim 13 wherein said means for transporting comprises a perforated conduit located at an upper end of said processing chamber and a channel in fluid communication with said conduit having a lower end open to said treating chamber for discharging said residual lighter phase thereinto.

19. The apparatus of claim 14 wherein said means for transporting comprises a perforated conduit located at a peak of said processing chamber and which extends across said coalescing media arrangement, and a vertically oriented channel in fluid communication with said conduit, said channel being located between said processing and treating chambers and having a lower end open to said treating chamber for discharging said residual lighter phase thereinto.

20. The apparatus of claim 18 wherein said treating chamber includes a means for accessing said processing chamber to allow heavier phase in said treating chamber to travel into said processing chamber.

21. The apparatus of claim 20 wherein said open lower end of said channel is located above said means for accessing said processing chamber.

22. The apparatus of claim 13 wherein said means for heating comprises at least one heater in contact with said lighter phase.

23. A method of processing fluids from an oil well comprising:
providing a separation apparatus for receiving said fluids, said apparatus being in the form of a pressure vessel having a hydrocyclone tube arrangement located therewithin;
passing said fluids through said hydrocyclone tube arrangement to urge separation of said fluids into a heavier phase and a lighter phase;
discharging said heavier phase from said pressure vessel; and,
providing said lighter phase with residence time sufficient for urging separation of residual heavier phase therefrom.

24. The method of claim 23 further comprising returning said residual heavier phase to said hydrocyclone tube arrangement for further processing.

25. The method of claim 24 further comprising providing said vessel with an overflow chamber downstream of said hydrocyclone tube arrangement for providing said residence time.

26. The method of claim 23 further comprising degassing said fluids prior to entering said separation apparatus.

27. The method of claim 25 further comprising providing said overflow chamber with means for monitoring the interface between said lighter phase and said residual heavier phase to maintain said interface at a desired level.

28. A method of processing fluids from an oil well having a lighter phase stream and a heavier phase stream comprising:
providing a treating apparatus for receiving said fluid streams, said apparatus being in the form of a vessel having a processing chamber for receiving said heavier phase stream and a treating chamber for receiving said lighter phase stream;
providing said heavier phase with sufficient residence time to urge separation of residual lighter phase therefrom;
transporting said residual lighter phase to said treating chamber;
providing said lighter phase and said residual lighter phase with residence time to urge further separation of residual heavier phase therefrom; and,
heating said treating chamber to enhance said further separation.

29. The method of claim 28 further comprising passing said heavier phase through a coalescing media arrangement for urging further separation of said residual lighter phase.

30. The method of claim 29 further comprising tilting said vessel at an oblique angle to the horizontal to further urge said passing of said heavier phase through said coalescing media arrangement.

31. The method of claim 28 further comprising allowing said residual heavier phase to pass into said processing chamber for further processing.

32. The process of claim 28 further comprising providing said treating chamber with means for monitoring the interface between said lighter phase and said residual heavier phase to maintain said interface at a desired level.

33. A method of processing fluids from an oil well comprising:
a) passing said fluids through at least one hydrocyclone to urge separation of said fluids into a heavier phase and a lighter phase;
b) providing said heavier phase with a residence time sufficient to urge separation by gravity of residual lighter phase therefrom;
c) providing said lighter phase with a first residence time sufficient to urge separation by gravity of residual heavier phase therefrom;
d) providing said lighter phase after step c) with a second residence time to urge by gravity further separation of more residual heavier phase therefrom; and,
e) heating said lighter phase during said second residence time to enhance said further separation.

34. The method of claim 33 further comprising degassing said fluids prior to step a).

35. The method of claim 33 further comprising returning said residual heavier phase after step c) to said at least one hydrocyclone for further processing.

36. The method of claim 33 further comprising passing said heavier phase in step b) through a coalescing media arrangement for uring further separation of said residual lighter phase.

37. The method of claim 33 further comprising adding said residual heavier phase from said second residence time in step d) to said heavier phase during said residence time of step b) for further processing.
